(19) United States
(12) Patent Application Publication
(10) Pub. No.: US 2026/0203132 A1
(43) Pub. Date: Jul. 16, 2026

(54) Predictive Instance Insights

(71) Applicant: ServiceNow, Inc., Santa Clara, CA (US)

(72) Inventors: Rajendar Reddy Kondam, Lake Zurich, IL (US); Sridhar Rao Vivaramneni, Aldie, VA (US); Rakesh Kumar Karrey, Mundelein, IL (US); Andrey Krasnyy, Livermore, CA (US)

(21) Appl. No.: 19/024,016

(22) Filed: Jan. 16, 2025

(51) Int. Cl. G06F 9/50; G06F 9/445

(52) U.S. Cl. CPC G06F 9/5055; G06F 9/44526

(57) ABSTRACT

At an orchestrator agent that manages a plurality of agents including a first agent and a second agent and in response to obtaining a request for a predicted behavior of a computing instance a method includes obtaining a respective plurality of metadata sets for the plurality of agents. The method includes generating a prompt based on at least a subset of the metadata sets via the orchestrator agent. The method includes obtaining a response to the request based on the prompt from the first agent and the second agent. The method includes performing an action directed to the computing instance. The action being based on the response.

### TECHNICAL FIELD

This disclosure relates to computing instances.

### BACKGROUND

Computing instances are copies of an operating system and the associated applications that run on a physical or cloud-based server. Computing instances may be used to perform various tasks, such as hosting websites, processing data, or running simulations. Current instance management approaches rely on dashboards that show historical and current health information of computing instances to both customers and internal support users. However, these dashboards only enable a reactive approach to troubleshooting, as actions are taken based on specific case tasks, alerts, or other triggers. This reactive approach often causes delays in resolving issues, which can affect system performance and increase downtime.

### SUMMARY

One implementation of the disclosure provides a computer-implemented method of generating instance insights. At an orchestrator agent that manages a plurality of agents including a first agent and a second agent and in response to obtaining a request for a predicted behavior of a computing instance, a method includes obtaining a respective plurality of metadata sets for the plurality of agents. The method includes generating a prompt based on at least a subset of the metadata sets via the orchestrator agent. The method includes obtaining a response to the request based on the prompt from the first agent and the second agent. The method includes performing an action directed to the computing instance. The action being based on the response.

Implementations of the disclosure may include one or more of the following optional features. In some implementations, the metadata sets are associated with different types of data. In these implementations, the different types of data may include a codebase of the computing instance, plug-ins associated with the computing instance, types of transactions requested by the computing instance, resource usage by the computing instance, and a configuration of the computing instance. Obtaining the request may include obtaining the request from a client system via a dashboard. In some examples, performing the action includes performing a remediation action on the computing instance. Performing the action may include performing an optimization action on the computing instance.

In some implementations, performing the action includes generating a graphical representation of the response and displaying the graphical representation via a dashboard. Each agent of the plurality of agents may correspond to an artificial intelligence (AI) agent or virtual agent. In some examples, the prompt requests an agent of the plurality of agents to retrieve historical usage data of a plurality of computing instances associated with the subset of the metadata sets. The method may further include generating another prompt based on at least another subset of the metadata sets, determining another response to the request based on the other prompt, and performing another action directed to the computing instance. The other action being based on the other response. Here, the other prompt requests an agent of the plurality of agents to retrieve historical usage data of a plurality of computing instances associated with the subset of metadata sets and the other subset of metadata sets. Determining the response may include determining the response using a first agent of the plurality of agents and determining the other response includes determining the other response using a second agent of the plurality of agents. In some examples, the first agent is conditioned to determine respective responses based on first data associated with the at least another subset of the metadata sets, and the second agent is conditioned to determine respective responses based on second data associated with the at least another subset of the metadata sets. In these examples, the first agent and the second agent are conditioned using at least one of prompt engineering, fine-tuning, or training.

In some implementations, the response predicts that an event associated with the computing instance will occur at a future time. In these implementations, the method may further include determining a likelihood that the event associated with the computing instance will occur at the future time. Here, performing the action reduces or increases the likelihood that the event will occur at the future time.

Another implementation of the disclosure provides a system that includes data processing hardware and memory hardware storing instructions that when executed on the data processing hardware causes the data processing hardware to perform operations. At an orchestrator agent that manages a plurality of agents including a first agent and a second agent and in response to obtaining a request for a predicted behavior of a computing instance, the operations include obtaining a respective plurality of metadata sets for the plurality of agents. The operations include generating a prompt based on at least a subset of the metadata sets via the orchestrator agent. The operations include obtaining a response to the request based on the prompt from the first agent and the second agent. The operations include performing an action directed to the computing instance. The action being based on the response.

Another implementation of the disclosure provides a computer-readable medium having instructions that, when executed by data processing hardware, causes the data processing hardware to perform operations. At an orchestrator agent that manages a plurality of agents including a first agent and a second agent and in response to obtaining a request for a predicted behavior of a computing instance, the operations include obtaining a respective plurality of metadata sets for the plurality of agents. The operations include generating a prompt based on at least a subset of the metadata sets via the orchestrator agent. The operations include obtaining a response to the request based on the prompt from the first agent and the second agent. The operations include performing an action directed to the computing instance. The action being based on the response.

The details of one or more implementations of the disclosure are set forth in the accompanying drawings and the description below. Other implementations, features, and advantages will be apparent from the description and drawings, and from the claims.

### DESCRIPTION OF DRAWINGS

FIG. 1 is a schematic view of an example system using an instance optimizer.

FIG. 2 is a schematic view of an example instance optimizer.

FIG. 3 is a flowchart of an example arrangement of operations for a first computer-implemented method of generating instance insights.

FIG. 4 is a flowchart of an example arrangement of operations for a second computer-implemented method of generating instance insights.

FIG. 5 is a schematic view of an example computing device that may be used to implement the systems and methods described herein.

Like reference symbols in the various drawings indicate like elements.

### DETAILED DESCRIPTION

Effective management of computing instances is essential for the seamless execution of numerous tasks and services. Computing instances, which are replicas of an operating system along with the associated applications, serve as the backbone of cloud computing environments, virtualized systems, and other IT infrastructures. These computing instances are employed to perform a diverse range of functions, from basic data processing to the hosting of sophisticated applications. Traditional approaches for managing computing instances involve using dashboards. Dashboards are sophisticated interfaces accessible to both customers and internal support users that serve as a centralized platform for monitoring the health and performance of computing instances. By providing insights into both historical and current data, dashboards enable users to track the status of computing instances over time. This information may be used for identifying trends, diagnosing issues, and making informed decisions about system maintenance and optimization.

However, the current approaches for managing computing instances are largely reactive in nature. Actions are typically initiated in response to specific case tasks, alerts, or other triggers that indicate a problem has already occurred. For example, if a computing instance experiences a performance degradation or a failure, the dashboard will alert the user, who can then take steps to address the issue. While this approach allows for the resolution of problems, it often results in delayed responses. The time taken to detect, diagnose, and rectify issues may lead to suboptimal system performance and increased downtime, which are detrimental to the overall efficiency and reliability of the IT infrastructure.

Accordingly, implementations herein are directed towards an instance optimizer. At an orchestrator agent that manages a plurality of agents including a first agent and a second agent, and in response to obtaining a request for a predicted behavior of a computing instance, the instance optimizer obtains a respective plurality of metadata sets for the plurality of agents. The instance optimizer, via the orchestrator agent, generates a prompt based on at least a subset of the metadata sets. The instance optimizer obtains a response to the request based on the prompt from the first agent and the second agent and performs an action directed to the computing instance. Here, the action is based on the response. In some implementations, the instance optimizer generates another prompt based on at least another subset of the metadata sets, determines another response to the request based on the other prompt, and performs another action based on the other response. Here, the instance optimizer may use a multi-agent framework whereby a first agent determines the response, and a second agent determines the other response.

Advantageously, the instance optimizer determines the response which may include predictive insights for a particular computing instance and performs an action based on the response. Thus, the predictive insights generator may reduce or increase a likelihood of an event predicted to occur in the future by performing the action. Moreover, the predictive insights generator leverages the multi-agent framework whereby the orchestrator agent orchestrates a plurality of agents whereby these agents may be artificial intelligence (AI) agents. Each worker agent is conditioned to determine predictive insights associated with a particular type of metadata based on historical usage data from the plurality of computing instances.

Traditional AI agent frameworks frequently employ monolithic architectures that use a single agent to perform tasks. Such monolithic architecture may result in inefficiencies, a higher likelihood of hallucinations, and limited reusability. These frameworks often lack the adaptability needed to integrate smoothly with existing tools and systems, posing challenges in utilizing previous investments in automation and workflows. Furthermore, the absence of a structured methodology for agent collaboration and task execution can lead to suboptimal performance and user experience. The multi-agent framework disclosed herein offers a solution to these challenges through a modular design that focuses on the creation and orchestration of multiple smaller agents, each assigned specific roles and capabilities. This modular approach minimizes hallucinations and enhances task resolution accuracy by ensuring that agents concentrate on well-defined tasks. The multi-agent framework employs the orchestrator agent to allocate tasks to the most suitable worker agents based on their capabilities and the task requirements. This central orchestrator manages the navigation and coordination among multiple worker agents, thereby improving overall efficiency.

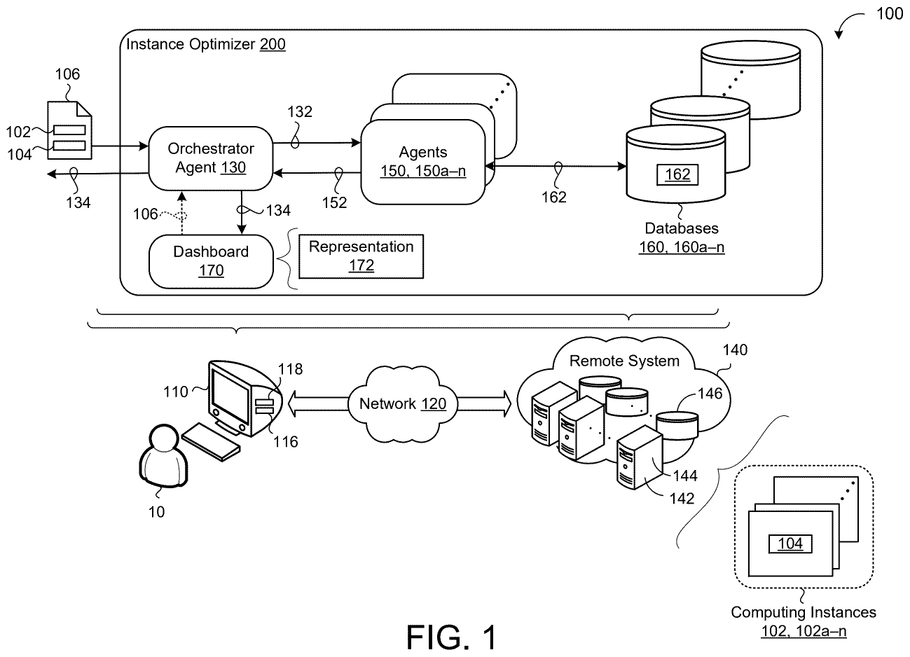

Referring to FIG. 1, in some implementations, a system 100 includes a remote system 140 in communication with one or more user device 110 each associated with a respective user 10 via a network 120, such as the Internet, a local area network (LAN), a wide area network (WAN), a cellular network, or a wireless network. The remote system 140 may be a single computer, multiple computers, or a distributed system (e.g., a cloud environment) having scalable/elastic resources 142 including computing resources 144 (e.g., data processing hardware) and/or storage resources 146 (e.g., memory hardware). The remote system 140 is configured to communicate with the user device 110 via the network 120. The user device 110 may correspond to any computing device, such as a desktop workstation, a laptop workstation, or a mobile device (i.e., a smart phone). Each user device 110 includes computing resources 116 (e.g., data processing hardware) and/or storage resources 118 (e.g., memory hardware).

The remote system 140 executes a plurality of computing instances 102, 102a-n. The computing instances 102 are virtual machines or containers that run applications or services on the remote system 140. A virtual machine is a software emulation of a physical computer that runs an operating system and applications independently of the underlying hardware. A container is a lightweight and isolated environment that runs an application or service without requiring a separate operating system. Each computing instance 102 of the plurality of computing instances 102 is associated with a metadata set 104. Each metadata set 104 includes a collection of information that describes the characteristics, properties, or attributes of the computing instance 102. The metadata sets 104 are associated with different types of data 162 that relate to the functionality, performance, or configuration of the computing instances 102. The data 162 represents usage history of the plurality of computing instances 102 and is stored at a plurality of databases 160. Thus, as will become apparent, the data 162 may be leveraged to determine predicted behaviors of particular computing instance 102 based on the data 162 that relates to the metadata set 104 of the particular computing instance 102.

The different types of data 162 may include, for example, a codebase of the computing instance 102, plug-ins associated with the computing instance 102, types of transactions requested by the computing instance 102, resource usage by the computing instance 102, and/or a configuration of the computing instance 102. The codebase may be the source code or executable code of the application or service that the computing instance 102 runs. For example, the codebase may be written in Java, Python, C#, or any other programming language. The plug-ins are additional modules or components that extend or modify the functionality of the application or service that the computing instance 102 runs. For example, the plug-ins may provide encryption compression, logging, or authentication features to the application or service. The types of transactions are the operations or actions that the computing instance 102 performs or receives from other computing instances 102 or external entities. For example, the types of transactions may include sending or receiving data, processing or validating requests, generating or displaying outputs, or initiating or terminating sessions. Resource usage by the computing instances 102 represents the amount or rates of consumption of the computing resources, such as CPU, memory, disk, network, or power, by the computing instance 102. The configuration of the computing instance 102 is the settings or parameters that define the behavior, appearance, or preferences of the computing instance 102. For example, the configuration may include the operating system version, the application or service version, the network address, the security policy, or the user interface of the computing instance.

The remote system 140 and/or the user device 110 may execute an instance optimizer 200. As will become apparent, the instance optimizer 200 is configured to predict instance insights for the computing instances 102 and, optionally, perform actions 134 based on the predicted instance insights. The instance optimizer 200 includes an orchestrator agent 130, a plurality of agents 150, the plurality of databases 160, and a dashboard 170. The orchestrator agent 130 manages the plurality of agents 150, 150a-n which may include a first agent 150a and a second agent 150b. The plurality of agents 150 may each be configured to perform different functions or tasks related to the prediction of the instance insights, such as data collection, data processing, data analysis, data modeling, data visualization, or data communication. The plurality of databases 160, 160a-n may store various types of data 162 or information related to the plurality of computing instances 102, such as historical data, current data, configuration data, metadata, and/or feedback data. Each type of data 162 may be associated with a portion of the metadata from the metadata set 104 of the computing instance 102.

The orchestrator agent 130 obtains a request 106 for a predicted behavior of a computing instance 102. The request 106 may specify one or more instance insights to be predicted, one or more computing instances 102 to be analyzed, one or more time periods or intervals to be considered, one or more parameters or criteria to be applied, or any combination thereof. Alternatively, the request 106 may generically request whether any optimizations may be made to improve one or more of the computing instances 102. In some examples, the orchestrator agent 130 obtains the request 106 from a client system (e.g., user device) 110 via the dashboard 170. The dashboard 170 may be a graphical user interface or a web-based application that allows the user 10 to interact with the instance optimizer 200 and view or modify the request 106. In other examples, the orchestrator agent 130 obtains the request 106 automatically, for instance, based on a predefined schedule, a threshold condition being satisfied, a policy, a rule, or a machine learning algorithm. For example, the instance optimizer 200 may generate the request 106 periodically, when the computing instance 102 reaches a certain level of utilization, when the user 10 changes the configuration of the computing instance 102, when the instance optimizer 200 detects an anomaly or a trend, when the instance optimizer 200 learns from the previous predictions or actions or based on determining that the computing instance 102 satisfies a threshold condition.

Based on the request 106, the orchestrator agent 130 obtains a respective plurality of metadata sets 104. In some examples, the respective plurality of metadata sets 104 may be included in the request 106 such that the orchestrator agent 130 obtains the respective plurality of metadata sets 104 from the request 106. In other examples, the orchestrator agent 130 obtains the respective plurality of metadata sets 104 based on the particular computing instance 102 of the request 106. For example, the orchestrator agent 130 may query, access, or retrieve the metadata sets 104 from one or more data sources, such as the computing instance 102 itself, the user device 110, the instance optimizer 200, an external data source, or a third-party service or system. The respective plurality of metadata sets 104 may include metadata only related to the computing instance 102 of the request 106 or metadata related to the plurality of computing instances 102.

The orchestrator agent 130 generates a prompt 132 based on at least a subset of the metadata sets 104. The prompt 132 may be a natural language query or a structured query that conveys the request 106 for the predicted behavior of the computing instance 102 to the plurality of agents 150. The subset of the metadata sets 104 may represent the metadata set 104 associated with the particular computing instance 102 of the request 106. Additionally or alternatively, the subset of the metadata sets 104 may be the particular portion of the plurality of metadata sets 104 related to a particular one of the agents 150. The orchestrator agent 130 sends the prompt 132 to the plurality of agents 150 which process the prompt 132 to generate a response 152.

The response 152 may include a prediction, a recommendation, a suggestion, a confirmation, or a clarification regarding the behavior of the computing instance 102. For example, the response 152 may include a prediction of the future resource demand, a recommendation of the optimal resource allocation, a suggestion of the best configuration, a confirmation of the current status, or a clarification of the request 106. In some implementations, the response 152 includes data 162 obtained by the plurality of agents 150. The orchestrator agent 130 receives the response 152 from the plurality of agents 150 and determines whether any action 134 needs to be taken based on the response 152. The action 134 may include adjusting resource allocations, triggering alerts, and/or updating configurations. The action 134 may be intended to improve, maintain, or optimize the performance, availability, cost, or security of the computing instance 102. Based on determining that an action 134 needs to be taken, the instance optimizer 200 performs the action 134 directed to the computing instance 102.

Each agent 150 of the plurality of agents 150 may correspond to an artificial intelligence (AI) agent or a virtual agent, for example, a large language model (LLM)-based agent. Moreover, each agent 150 of the plurality of agents 150 is conditioned using at least one of prompt engineering, fine-tuning, or training. Prompt engineering refers to the process of designing and refining the prompt 132 to elicit the desired response 152 from the agent 150. Prompt engineering may involve selecting the appropriate format, structure, syntax, vocabulary, tone, or style of the prompt 132 to match the capabilities, preferences, or expectations of the agent 150. Fine-tuning refers to the process of adapting and modifying the agent 150 to a specific domain or task using a subset of data or parameters. Fine-tuning may involve adjusting the weights, biases, hyperparameters, or settings of the agent 150 to improve its accuracy, relevance, or efficiency for the domain or task of the request 106. Training refers to the process of learning and improving the agent using a large amount of training data.

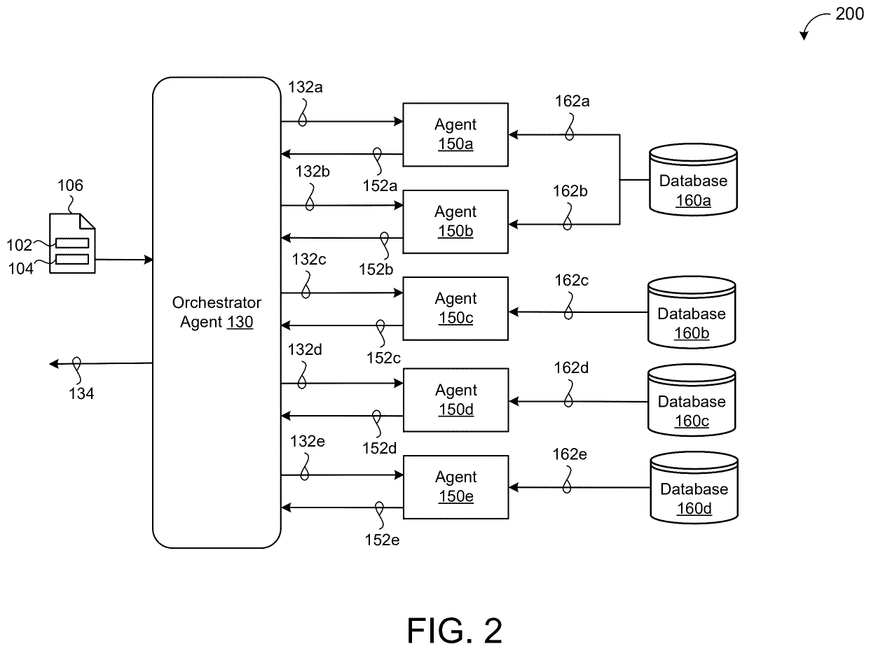

The prompt 132 serves as a directive for the agents 150 to perform specific tasks or analyses. For instance, as discussed in greater detail with reference to FIG. 2, the first agent 150a may be tasked with retrieving a first type of data 162 from the plurality of databases 160 while the second agent 150b is tasked with retrieving a second type of data 162 from the plurality of databases 160. The first agent 150a and the second agent 150b generate the response 152 based on the retrieved data 162. In some implementations, the response 152 includes the first type of data 162 and the second type of data 162. In other implementations, the response includes predicted behaviors of the computing instance 102 based on the first type of data 162 and the second type of data 162. For example, the first type of data 162 might include activity logs, while the second type of data 162 might include system performance metrics. The agents 150 analyze these data types to generate a comprehensive response 152 that predicts the behavior of the computing instance or includes a comprehensive dataset associated with the computing instance 102.

When the orchestrator agent 130 determines an action 134 needs to be performed based on the response 152, the orchestrator agent 130 determines the particular action 134 to be performed. Thereafter, the instance optimizer 200 performs the action 134 directed to the computing instance 102. In some implementations, performing the action 134 includes generating a graphical representation 172 of the response 152 and displaying the graphical representation via the dashboard 170. That is, the graphical representation 172 may be a textual representation of the action 134 performed on the computing instance 102. For example, the graphical representation 172 may show a textual description of the action 134 performed on the computing instance 102, such as “increased CPU allocation by 10%” or “applied security patch 1.2.3.”

In some examples, the graphical representation 172 is presented via the dashboard 170 before performing the action 134 on the computing instance 102. As such, the user 10 may review and approve the action 134 before performing the action on the computing instance 102. Here, the instance optimizer 200 may perform the action 134 responsive to receiving an approval from the user 10. Alternatively, the instance optimizer 200 may execute the action 134 automatically without requiring any approval response from the user 10. Additionally or alternatively, performing the action 134 may include performing a remediation action on the computing instance 102. For example, if the response 152 indicates that the computing instance 102 is underutilized, the action 134 may involve reallocating resources to optimize performance. Conversely, if the response 152 indicates an anomaly or potential failure, the action 134 may involve triggering an alert to notify the user 10 or initiating a corrective measure to prevent downtime. In some examples, performing the action 134 includes performing an optimization action on the computing instance 102, such as adjusting configurations to enhance efficiency or applying updates to improve security and functionality.

The response 152 may predict that an event associated with the computing instance 102 will (or will not) occur at a future time. The event may be any occurrence that affects the performance, functionality, availability, or security of the computing instance 102. For example, the event may be a spike in demand, a network outage, a hardware malfunction, or a cyberattack. The plurality of agents 150 or the orchestrator agent 130 may determine a likelihood that the event associated with the computing instance 102 will occur at the future time. Accordingly, performing the action 134 may reduce or increase the likelihood that the event will occur at the future time, depending on the desired outcome. For example, if the response 152 predicts a high likelihood of a security breach, the action 134 may involve implementing additional security measures to reduce this likelihood. Conversely, if the response 152 predicts a low likelihood of system failure, the action 134 may involve reducing the frequency of maintenance checks to optimize resource allocation.

FIG. 2 illustrates an example instance optimizer 200 that optimizes a computing instance 102 based on the metadata set 104 of the computing instance 102 and retrieved data 162. In this example, the instance optimizer 200 includes the orchestrator agent 130, five agents 150, 150 a-e, and four databases 160, 160a-d. The orchestrator agent 130 receives the request 106 for the computing instance 102. Here, the request 106 includes the metadata set 104 associated with the computing instance 102. Based on the request 106, the orchestrator agent 130 generates one or more prompts 132, 132a-e for the plurality of agents 150. Each prompt 132 requests one of the agents 150 of the plurality of agents 150 to retrieve historical usage data 162 of the plurality of computing instances 102 associated with the subset of metadata sets 104. That is, the prompt 132 requests one of the agents 150 to retrieve historical usage data 162 recorded from the plurality of computing instances 102 that have a subset of metadata sets 104 similar or identical to the metadata set 104 of the computing instance 102. Put another way, each prompt 132 requests one of the agents 150 to retrieve historical usage data 162 that is uniquely associated with a particular portion of the metadata set 104 of the computing instance 102 and that reflects the past performance and behavior of the computing instance 102 or other computing instances 102 with the same or similar portion of the metadata set 104.

For example, as shown in FIG. 2, the orchestrator agent 130 generates the first prompt 132a and the second prompt 132b for the first agent 150a and the second agent 150b, respectively. The first agent 150a may be conditioned to retrieve first historical usage data 162, 162a from the first database 160a corresponding to problems records data associated with the computing instance 102. The problem records data may include information about the frequency, severity, duration, and resolution of any issues or errors that occurred on the computing instance 102 or any of the plurality of computing instances 102 with similar problem records data. For instance, the problem record data may indicate how often the computing instance 102 experienced downtime, latency, memory leaks, security breaches, or other problems, how severe those problems were, how long they lasted, and how they were resolved. Moreover, the second agent 150b is conditioned to retrieve second historical usage data 162, 162b from the first database 160a corresponding to cases data associated with the computing instance 102. The cases data may include information about the number, type, status, and outcome of any requests, incidents, or changes that involved the computing instance 102 or any of the plurality of computing instances 102 with similar cases data.

As such, the orchestrator agent 130 may generate the first prompt 132a based on problems records data portion of the metadata set 104 and generate the second prompt 132b based on cases data portion of the metadata set 104. The first prompt 132a may request the first agent 150a to retrieve and analyze the first historical usage data 162a that matches or is similar to the problem record data of the computing instance 102 and provide a first response 152, 152a. The first response may include the relevant problem record data, as well as recommendations, suggestions, or actions to improve the performance and efficiency of the computing instance 102 based on the problem record data. For example, the first response 152a may indicate that the computing instance 102 had a high frequency of memory leaks that caused downtime and latency, and suggest increasing the memory allocation, monitoring the memory usage, or updating the software to prevent or resolve the memory leaks. Similarly, the second prompt 132b may request the second agent 150b to retrieve and analyze the second historical usage data 162b that matches or is similar to the cases data of the computing instance 102 and to provide a second response 152, 152b that includes the relevant cases data, as well as recommendations, suggestions, or actions to improve the performance and efficiency of the computing instance 102 based on the cases data. For example, the second response 152b may indicate that the computing instance 102 had a low number of requests for backup or migration, and suggest increasing the frequency, quality, or security of the backup or migration processes to ensure the availability and reliability of the computing instance 102.

The orchestrator agent 130 generates a third prompt 132, 132c for the third agent 150c based on the request 106 and the first and second responses 152a, 152b. Here, the third agent 150c may be conditioned to retrieve third historical usage data 162, 162c from the second database 160b corresponding to instance specific data associated with the computing instance 102, such as plug-ins installed. As such, the orchestrator agent 130 may generate the third prompt 132c based on plug-in information of the metadata set 104 and the first and second responses 152a, 152b. That is, the third prompt 132c may request the third agent 150c to narrow down the first and second historical usage data 162a, 162b based on the plug-ins installed for the computing instance 102 and to provide a third response 152, 152c. The third agent 150c may compare the plug-ins installed for the computing instance 102 with the plug-ins installed for other computing instances 102 that had similar or comparable problem record data or cases data and select the historical usage data 162 that is most relevant or useful for the optimization or enhancement of the computing instance 102. The third agent 150c processes the third prompt 132c to generate the third response 152c.

The third response 152c may include the relevant instance specific data, as well as recommendations, suggestions, or actions to improve the performance and efficiency of the computing instance 102 based on the instance specific data. For example, the third response 152c may indicate that the computing instance 102 had a plug-in that was incompatible with the software version or the hardware configuration, and suggest removing, replacing, or updating the plug-in to avoid conflicts or errors. Alternatively, the third response 152c may indicate that the computing instance 102 had a plug-in that enhanced the functionality or security of the computing instance 102, and suggest keeping, optimizing, or expanding the plug-in to leverage its benefits. In some implementations, the third response 152c filters the first and second historical usage data 162a, 162b to only include historical usage data 162 relevant to plug-ins installed on the computing instance 102. For example, the third response 152c may exclude historical usage data 162 that relates to problems or cases that were caused or resolved by different plug-ins or no plug-ins at all.

Continuing with the example shown, the orchestrator agent 130 generates a fourth prompt 132, 132d for the fourth agent 150d based on the request 106 and the third response 152c. The fourth agent 150d may be conditioned to retrieve fourth historical usage data 162, 162d from the third database 160c corresponding to instance transactions patterns. Instance transactions patterns may refer to the patterns of data or service exchanges between the computing instance 102 and other entities, such as customers, service providers, or other computing instances. For example, instance transactions patterns may include the volume, frequency, duration, or quality of the transactions, as well as the types, sources, or destinations of the transactions. As such, the orchestrator agent 130 may generate the fourth prompt 132d based on transaction pattern information of the metadata set 104 and the third response 152c. That is, the fourth prompt 132d may request the fourth agent 150d to further narrow down the first and second historical usage data 162a, 162b based on the transaction patterns of the computing instance 102. The third response 152c may include the narrowed down historical usage data 162 from the third agent 150c that the fourth agent 150d narrows down even further. The fourth agent 150d may compare the transaction patterns for the computing instance 102 with the transaction patterns for other computing instances 102 that had similar or comparable problem record data or cases data and select the historical usage data 162 that is most relevant or useful for the optimization or enhancement of the computing instance 102. The fourth agent 150d processes the fourth prompt 132d to generate a fourth response 152, 152d based on the fourth historical usage data 162d.

The fourth response 152d may include the relevant transaction pattern data, such as the number, size, time, or quality of the transactions, as well as the transaction type, source, or destination, as well as recommendations, suggestions, or actions to improve the performance and efficiency of the computing instance 102 based on the transaction pattern data. For example, the fourth response 152d may indicate that the computing instance 102 had a high volume of transactions with a particular customer or service provider, and suggest increasing the bandwidth, capacity, or security of the communication channel with that entity to ensure the satisfaction and loyalty of the customer or service provider. Alternatively, the fourth response 152d may indicate that the computing instance 102 had a low frequency of transactions with a particular customer or service provider, and suggest improving the marketing, pricing, or quality of the service offered by the computing instance 102 to attract and retain more customers or service providers. In some implementations, the fourth response 152d filters the first and second historical usage data 162a, 162b to only include historical usage data 162 relevant to transaction patterns of the computing instance 102. For example, the fourth response 152d may exclude historical usage data 162 that relates to problems or cases that were caused or resolved by different transaction patterns or no transaction patterns at all. This may reduce the noise or irrelevant data that may interfere with the optimization or enhancement of the computing instance 102.

Finally, the orchestrator agent 130 generates a fifth prompt 132, 132e for the fifth agent 150e based on the request 106 and the fourth response 152d. The fifth agent 150e may be conditioned to retrieve fifth historical usage data 162, 162e from the fourth database 160d corresponding to instance observability data. Instance observability data may refer to the data that reflects the state, behavior, or performance of the computing instance 102, such as metrics, logs, traces, or alerts. For example, instance observability data may include the CPU, memory, disk, or network utilization, the error or exception rates, the response or latency times, or the availability or reliability indicators of the computing instance 102. As such, the orchestrator agent 130 may generate the fifth prompt 132e based on instance observability data of the metadata set 104 and the fourth response 152d. That is, the fifth prompt 132e may request the fifth agent 150e to even further narrow down the first and second historical usage data 162a, 162b based on the instance observability data of the computing instance 102. The fourth response 152d may include the narrowed down historical usage data 162 from the fourth agent 150d that the fifth agent 150e narrows down even further. The fifth agent 150e may compare the instance observability data for the computing instance 102 with the instance observability data for other computing instances 102 that had similar or comparable problems records data or cases data and select the historical usage data 162 that is most relevant or useful for the optimization or enhancement of the computing instance 102. The fifth agent 150e processes the fifth prompt 132e to generate a fifth response 152, 152e based on the fifth historical usage data 162e.

The fifth response 152e may include the relevant instance observability data, such as the CPU, memory, disk, or network utilization, the error or exception rates, the response or latency times, or the availability or reliability indicators of the computing instance 102, as well as recommendations, suggestions, or actions to improve the performance and efficiency of the computing instance 102 based on the instance observability data. For example, the fifth response 152e may indicate that the computing instance 102 had a high CPU utilization that affected the response time and the availability of the computing instance 102, and suggest reducing the CPU load, balancing the CPU resources, or upgrading the CPU hardware to improve the response time and the availability of the computing instance 102. Alternatively, the fifth response 152e may indicate that the computing instance 102 had a low error rate that indicated the reliability and quality of the computing instance 102, and suggest maintaining, monitoring, or testing the error handling mechanisms to ensure the reliability and quality of the computing instance 102. In some implementations, the fifth response 152e filters the first and second historical usage data 162a, 162b to only include historical usage data 162 relevant to instance observability data of the computing instance 102. For example, the fifth response 152e may exclude historical usage data 162 that relates to problems or cases that were caused or resolved by different instance observability data or no instance observability data at all. This may reduce the noise or irrelevant data that may interfere with the optimization or enhancement of the computing instance 102.

Thereafter, the orchestrator agent 130 determines an action 134 to perform on the computing instance 102 based on the fifth response 152e. The action 134 may include applying, modifying, or removing any of the recommendations, suggestions, or actions provided by the responses 152a-e, or any combination thereof, to optimize or enhance the performance and efficiency of the computing instance 102. For example, the action 134 may include increasing the memory allocation, updating the software, removing the incompatible plug-in, increasing the backup frequency, or improving the response time of the computing instance 102. In some examples, the responses 152a-e only includes the retrieved data 162 relevant to the computing instance 102 such that the orchestrator agent 130 determines the action 134 to perform based on the retrieved data 162. The orchestrator agent 130 may execute the action 134 on the computing instance 102 directly or indirectly, such as by sending instructions, commands, or signals to the computing instance 102 or to another entity that performs the action 134 on the computing instance 102. The orchestrator agent 130 may also provide feedback, confirmation, or notification of the action 134 to the user 10, the service provider, or the computing instance 102.

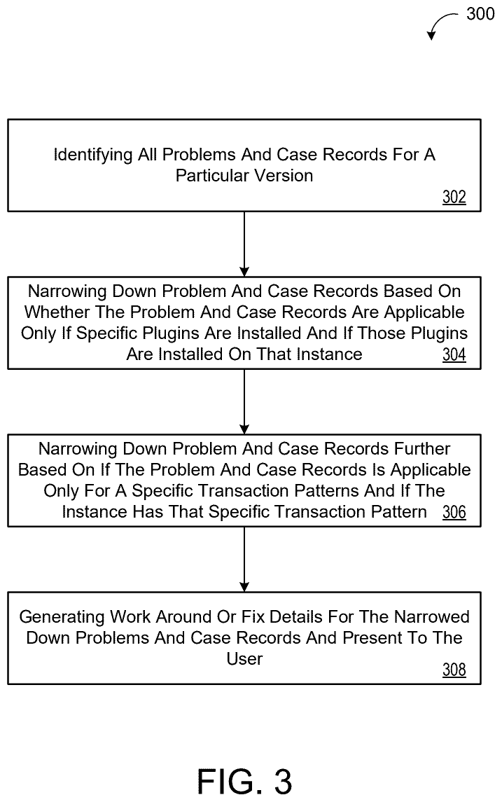

FIG. 3 is a flowchart of an exemplary arrangement of operations for a computer-implemented method 300 of generating instance insights. In particular, the method 300 illustrates an example use case of the instance optimizer 200 generating a response 152 for a request 106. At operation 302, the method 300 includes identifying all problem and case records for a particular version of a computing instance 102. For instance, the first agent 150a may obtain problems records from the first database 160a and the second agent 150b may obtain cases data from the first database 160a. As such, the problem and case records may provide a comprehensive dataset associated with the computing instance 102 for the instance optimizer 200 to start with. At operation 304, the method 300 includes narrowing down the problem and case records from operation 302 based on whether the problem and case records are applicable to plug-ins associated with the computing instance 102. For instance, the instance optimizer 200 may narrow down by filtering the problem and case records from operation 302 to include only those that are relevant to specific plug-ins installed on the computing instance 102.

At operation 306, the method 300 includes further narrowing down the problem and case records from operation 304 based on whether the problem and case records are applicable to transaction patterns associated with the computing instance 102. That is, the instance optimizer 200 may narrow down by further filtering the problem and case records to include only those that are relevant to specific transaction patterns associated with the computing instance 102. In some implementations, if a particular transaction pattern frequently leads to a specific type of problem, the instance optimizer 200 will prioritize those records. At operation 308, the method 300 includes generating work around or fixing details (i.e., the action 134) for the narrowed-down problems and case records from operation 306 and presenting these details to the user 10. For instance, if the instance optimizer 200 identifies a recurring issue with a specific plug-in during a particular transaction pattern, it may suggest a workaround such as updating the plug-in or altering the transaction process. The generated workarounds or fixes are then presented to the user 10, providing actionable insights to resolve the identified issues effectively.

The narrowing down process advantageously enables the instance optimizer 200 to focus on the most relevant and significant problem and case records that affect the performance or functionality of the computing instance 102 or its plug-ins. By narrowing down the problem and case records based on the plug-ins and the transaction patterns associated with the computing instance 102, the instance optimizer 200 may eliminate unnecessary or irrelevant records that may clutter or confuse the analysis or the presentation of the instance insights. The narrowing down process may also improve the efficiency and accuracy of the instance optimizer 200, as it can reduce the amount of data that needs to be processed, analyzed, or displayed. As a result, the instance optimizer 200 may generate outputs with reduced latency, use fewer computing resources, and/or generate tailored outputs.

In contrast to traditional instance management approaches that are largely reactive, the instance optimizer 200 may proactively perform the actions 134 to prevent unwanted events from occurring before they become a problem. The instance optimizer 200 uses the orchestrator agent 130 to manage a plurality of agents 150 to predict behaviors of computing instances 102 and perform actions 134 based on these predictions. Each agent 150 is conditioned to handle specific types of metadata associated with computing instances 102, such as codebase, plug-ins, transaction types, resource usage, and configuration data. By generating prompts 132 based on subsets of these metadata sets 104, the orchestrator agent 130 obtains responses 152 from the agents 150 that include predictive insights. These insights may predict future events, such as performance degradation or security breaches, and determine the likelihood of these events occurring. Based on the responses 152, the instance optimizer 200 performs various actions 134, including remediation and optimization, to either reduce or increase the likelihood of the predicted events.

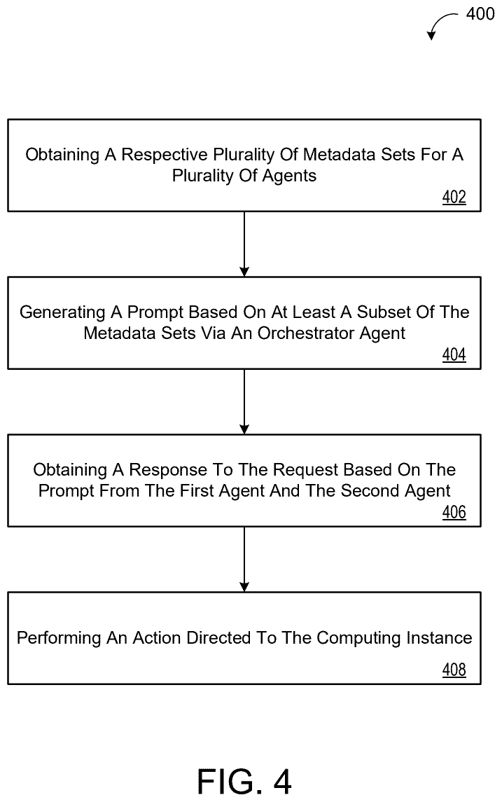

FIG. 4 is a flowchart of an exemplary arrangement of operations for a computer-implemented method 400 of generating instance insights. At an orchestrator agent 130 that manages a plurality of agents 150 including a first agent 150a and a second agent 150b, and in response to obtaining a request 106 for a predicated behavior of a computing instance 102, the method 400 performs operations 402-408. At operation 402, the method 400 includes obtaining a respective plurality of metadata sets 104. The respective plurality of metadata sets 104 may be related to the computing instance 102 of the request 106. At operation 404, the method 400 includes generating, via the orchestrator agent 130, a prompt 132 based on at least a subset of the metadata sets 104. Here, the at least subset of metadata sets 104 may include metadata associated with the computing instance 102 or metadata associated with a respective one of the agents 150. As such, the orchestrator agent 130 generates the prompt 132 specifically for the computing instance 102 and/or the particular agent 150 that will be processing the prompt 132. At operation 406, the method 400 includes obtaining a response 152 to the request 106 based on the prompt 132 from the first agent 150a and the second agent 150b. At operation 408, the method 400 includes performing an action 134 directed to the computing instance 102. Here, the action 134 is based on the response 152. Advantageously, since the response 152 is determined based on the subset of metadata 104, the response 152 is tailored for the particular computing instance 102 and the action 134 on the computing instance 102.

The instance optimizer 200 improves the efficiency and reliability of managing computing instances 102 by the plurality of agents 150 that are conditioned to retrieve and analyze different types of data 162 associated with the computing instances 102 and the corresponding metadata sets 104. The instance optimizer 200 also employs the orchestrator agent 130 that coordinates and orchestrates the plurality of agents 150 to generate response 152 based on prompts 132 to predict behaviors of the computing instances 102. Moreover, the instance optimizer 200 further performs actions 134 directed to the computing instances 102 based on the responses 152, such as remediation, optimization, or visualization actions, to enhance the performance, functionality, availability, or security of the computing instances 102. Thus, the instance optimizer 200 provides proactive and tailored instance management solutions using a modular and adaptable multi-agent framework that minimizes hallucinations, maximizes task resolution accuracy, and integrates smoothly with existing tools and systems. Since the instance optimizer 200 may perform the actions 134 automatically (e.g., without input from the user 10), the instance optimizer 200 may proactively optimize the plurality of computing instances 102 rather than reactively addressing problems as they arise.

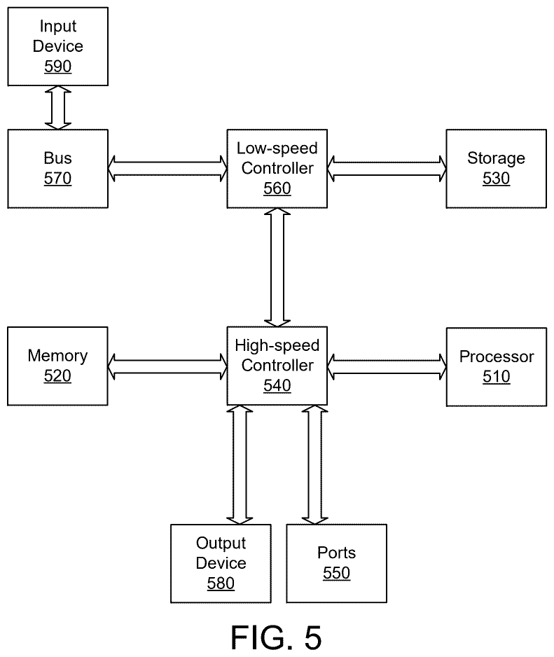

FIG. 5 is a schematic view of an example computing device 500 that may be used to implement the systems and methods described in this document. The computing device 500 is intended to represent various forms of digital computers, such as laptops, desktops, workstations, tablets, smartphones, servers, blade servers, mainframes, and other appropriate computers. The components shown here, their connections and relationships, and their functions, are meant to be illustrative only, and are not meant to limit implementations described and/or claimed in this document.

The computing device 500 includes a processor 510, memory 520, a storage device 530, a high-speed interface/controller 540 connecting to the memory 520 and high-speed expansion ports 550, and a low-speed interface/controller 560 connecting to a low-speed bus 570 and a storage device 530. Each of the components 510, 520, 530, 540, 550, and 560, are interconnected using various busses, and may be mounted on a common motherboard or in other manners as appropriate. The processor 510 can execute instructions for performing operations within the computing device 500, including instructions stored in the memory 520 or on the storage device 530 to display graphical information for a graphical user interface (GUI) on an external input/output device, such as display 580 coupled to high-speed interface 540. In other implementations, multiple processors and/or multiple buses may be used, as appropriate, along with multiple memories and types of memory. Also, multiple computing devices 500 may be connected, with each device providing portions of the necessary operations (e.g., as a server cluster, a group of blade servers, or a multi-processor system).

The memory 520 stores information within the computing device 500. The memory 520 may be a non-transitory computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random-access memory (DRAM), static random-access memory (SRAM), phase change memory (PCM) as well as disks or tapes.

The storage device 530 is capable of providing mass storage for the computing device 500. In some implementations, the storage device 530 is a non-transitory computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is embodied in a non-transitory information carrier. The computer program product contains instructions that, when executed, perform one or more methods, such as those described above. The information carrier is a non-transitory computer-readable medium, such as the memory 520, the storage device 530, or memory on processor 510.

The high-speed controller 540 manages bandwidth-intensive operations for the computing device 500, while the low-speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port or input device 590. The low-speed expansion port 590, which may include various communication ports (e.g., USB, Bluetooth, Ethernet, wireless Ethernet), may be coupled to one or more input/output devices, such as a keyboard, a pointing device, a microphone, a touch screen, a scanner, or a networking device such as a switch or router, e.g., through a network adapter.

The computing device 500 may be implemented in a number of different forms, as shown in the figure. For example, it may be implemented as a standard server 500a or multiple times in a group of such servers 500a, as a laptop computer 500b, or as part of a rack server system 500c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the term “non-transitory computer-readable medium” refers to any computer program product, apparatus and/or device (e.g., magnetic discs, optical disks, memory, Programmable Logic Devices (PLDs)) used to provide machine instructions and/or data to a programmable processor, including a non-transitory computer-readable medium that receives machine instructions as a non-transitory computer-readable signal. The term “non-transitory computer-readable signal” refers to any signal used to provide machine instructions and/or data to a programmable processor.

A software application (i.e., a software resource) may refer to computer software that instructs a computing device to perform a specific function or set of functions. A software application may be executed by a processor, a virtual machine, a web browser, or another software component on the computing device. In some examples, a software application may be referred to as an “application,” an “app,” a “program,” or a “service.” Example applications include, but are not limited to, system diagnostic applications, system management applications, system maintenance applications, word processing applications, spreadsheet applications, messaging applications, media streaming applications, social networking applications, gaming applications, e-commerce applications, cloud computing applications, artificial intelligence applications, and blockchain applications.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a non-volatile memory or a volatile memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Non-transitory computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more implementations of the disclosure can be implemented on a computer having a display device, e.g., a LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

1. A computer-implemented method comprising, at an orchestrator agent that manages a plurality of agents including a first agent and a second agent, in response to obtaining a request for a predicted behavior of a computing instance:
obtaining, for the plurality of agents, a respective plurality of metadata sets;
generating, via the orchestrator agent, a prompt based on at least a subset of the metadata sets;
obtaining, from the first agent and the second agent, a response to the request based on the prompt; and
performing an action directed to the computing instance, the action being based on the response.

2. The method of claim 1, wherein the metadata sets are associated with different types of data.

3. The method of claim 2, wherein the different types of data comprise:
a codebase of the computing instance;
plug-ins associated with the computing instance;
types of transactions requested by the computing instance;
resource usage by the computing instance; and
a configuration of the computing instance.

4. The method of claim 1, wherein obtaining the request comprises obtaining the request, via a dashboard, from a client system.

5. The method of claim 1, wherein performing the action comprises performing a remediation action on the computing instance.

6. The method of claim 1, wherein performing the action comprises performing an optimization action on the computing instance.

7. The method of claim 1, wherein performing the action comprises:
generating a graphical representation of the response; and
transmitting, to a user device, data configured to cause the user device to display, via a dashboard, the graphical representation.

8. The method of claim 1, wherein each agent of the plurality of agents corresponds to an artificial intelligence (AI) agent or virtual agent.

9. The method of claim 1, wherein the prompt requests an agent of the plurality of agents to retrieve historical usage data of a plurality of computing instances associated with the subset of the metadata sets.

10. The method of claim 1, further comprising:
generating another prompt based on at least another subset of the metadata sets;
determining another response to the request based on the other prompt; and
performing another action directed to the computing instance, the other action being based on the other response.

11. The method of claim 10, wherein the other prompt requests an agent of the plurality of agents to retrieve historical usage data of a plurality of computing instances associated with the subset of metadata sets and the other subset of metadata sets.

12. Th method of claim 10, wherein:
determining the response comprises determining the response using a first agent of the plurality of agents; and
determining the other response comprises determining the other response using a second agent of the plurality of agents.

13. The method of claim 12, wherein:
the first agent is conditioned to determine respective responses based on first data associated with the at least another subset of the metadata sets; and
the second agent is conditioned to determine respective responses based on second data associated with the at least another subset of the metadata sets.

14. The method of claim 13, wherein the first agent and the second agent are conditioned using at least one of:
prompt engineering;
fine-tuning; or
training.

15. The method of claim 1, wherein obtaining the request comprises:
determining that the computing instance satisfies a threshold condition; and
based on determining that the computing instance satisfies the threshold condition, generating the request.

16. The method of claim 1, wherein the response predicts that an event associated with the computing instance will occur at a future time.

17. The method of claim 16, further comprising determining a likelihood that the event associated with the computing instance will occur at the future time.

18. The method of claim 17, wherein performing the action reduces or increases the likelihood that the event will occur at the future time.

19. A system comprising:
data processing hardware; and
memory hardware in communication with the data processing hardware, the memory hardware storing instructions that when executed on the data processing hardware cause the data processing hardware to perform operations comprising, at an orchestrator agent that manages a plurality of agents including a first agent and a second agent, in response to obtaining a request for a predicted behavior of a computing instance:
obtaining, for the plurality of agents, a respective plurality of metadata sets;
generating, via the orchestrator agent, a prompt based on at least a subset of the metadata sets;
obtaining, from the first agent and the second agent, a response to the request based on the prompt; and
performing an action directed to the computing instance, the action being based on the response.

20. A computer-readable medium having instructions that, when executed by data processing hardware, causes the data processing hardware to perform operations comprising, at an orchestrator agent that manages a plurality of agents including a first agent and a second agent, in response to obtaining a request for a predicted behavior of a computing instance:
obtaining, for the plurality of agents, a respective plurality of metadata sets;
generating, via the orchestrator agent, a prompt based on at least a subset of the metadata sets;
obtaining, from the first agent and the second agent, a response to the request based on the prompt; and
performing an action directed to the computing instance, the action being based on the response.
